(19) United States
(12) Patent Application Publication
(10) Pub. No.: US 2019/0033959 A1
(43) Pub. Date: Jan. 31, 2019

(54) VIRTUAL REALITY INTERFACE

(71) Applicant: Ernst Nathaniel Blanchard, JR., Brooklyn, NY (US)

(72) Inventor: Ernst Nathaniel Blanchard, JR., Brooklyn, NY (US)

(21) Appl. No.: 15/827,766

(22) Filed: Nov. 30, 2017

Related U.S. Application Data
(60) Provisional application No. 62/537,683, filed on Jul. 27, 2017.

(51) Int. Cl. G06F 3/01; B25J 11/00; B25J 9/00; B25J 9/06; B25J 18/02

(52) U.S. Cl. CPC G06F 3/011; B25J 11/003; B25J 18/025; B25J 9/06; B25J 9/0018

(57) ABSTRACT

A virtual reality interface. The virtual reality interface includes a user attachment, a robotic arm, and a structural mount. The user attachment is configured to attach to a body of a user. The structural mount is configured to attach to a structure. The robotic arm is electrically connected to and controlled by a computer. The robotic arm includes a plurality of segments joined together. The plurality of segments at least includes a first end segment coupled to the user attachment and a second end segment coupled to the structural mount. Each of the segments includes a first pivoting member operable to rotate about a horizontal axis and a second pivoting member operable to rotate about a vertical axis. At least one motor drives the first pivoting member to rotate about the horizontal axis and drives the second pivoting member to rotate about the vertical axis.

### CROSS-REFERENCE TO RELATED APPLICATION

This application claims the benefit of priority of U.S. provisional application No. 62/537,683, filed Jul. 27, 2017, the contents of which are herein incorporated by reference.

### BACKGROUND OF THE INVENTION

The present invention relates to virtual reality and, more particularly, to a virtual reality interface.

Virtual reality (VR) is a computer technology that uses virtual reality headsets or multi-projected environments, sometimes in combination with physical environments or props, to generate realistic images, sounds and other sensations that simulate a user's physical presence in a virtual or imaginary environment. A person using virtual reality equipment is able to “look around” the artificial world, and with high quality VR move around in it and interact with virtual features or items. The effect is commonly created by VR headsets consisting of head-mounted goggles with a screen in front of the eyes, but can also be created through specially designed spaces with multiple large screens.

A VR headset visually simulates a user's physical presence in a virtual environment. Sensors, controllers and haptic feedback devices may be used to enhance the interaction of the user beyond the visual stimulation. However, the above-mentioned technologies do not seamlessly translate movement from the virtual world to the real world and vice versa.

As can be seen, there is a need for a body suit that seamlessly translates movement from the virtual world to the real world and vice versa.

### SUMMARY OF THE INVENTION

In one aspect of the present invention, a virtual reality interface comprises: a user attachment configured to attach to a body of a user; a structural mount configured to attach to a structure; a robotic arm electrically connected to and controlled by a computer, wherein the robotic arm comprises a plurality of segments joined together, the plurality of segments comprising at least a first end segment coupled to the user attachment and a second end segment coupled to the structural mount, wherein each of the plurality of segments comprise: a first pivoting member operable to rotate about a horizontal axis; and a second pivoting member operable to rotate about a vertical axis; and at least one motor driving the first pivoting member to rotate about the horizontal axis and driving the second pivoting member to rotate about the vertical axis.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in an exemplary initial state;

FIG. 2 is a schematic view of an embodiment of the present invention shown in use;

FIG. 3 is a detail perspective view of an embodiment of the present invention shown in an exemplary secondary state;

FIG. 4 is a detail perspective view of an embodiment of the present invention shown in an exemplary initial state;

FIG. 5 is a detail perspective view of an embodiment of the present invention shown in an exemplary secondary state;

FIG. 6 is a detail exploded view of an embodiment of the present invention;

FIG. 7 is a detail perspective view of an embodiment of components of the present invention shown in an exemplary initial state;

FIG. 8 is a detail perspective view of an embodiment of components of the present invention shown in an exemplary secondary state;

FIG. 9 is a detail section view of the present invention taken along line 9-9 in FIG. 8;

FIG. 10 is a rear detail exploded view of an embodiment of the present invention;

FIG. 11 is a rear detail perspective view of an embodiment of the present invention;

FIG. 12 is a rear detail perspective view of an embodiment of the present invention demonstrating lateral translation;

FIG. 13 is a rear detail perspective view of an embodiment of the present invention demonstrating lateral translation;

FIG. 14 is a detail section view of the present invention taken along line 14-14 in FIG. 11;

FIG. 15 is a rear detail perspective view of an embodiment of the present invention demonstrating vertical translation;

FIG. 16 is a rear detail perspective view of an embodiment of the present invention demonstrating vertical translation;

FIG. 17 is a detail section view of the present invention taken along line 17-17 in FIG. 16;

FIG. 18 is a perspective view of components of an embodiment of the present invention;

FIG. 19 is side view of components of an embodiment of the present invention; and

FIG. 20 is a perspective view of an embodiment of the present invention shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an interface between virtual reality and the real world. The present invention collects data from the virtual world (the user is being lifted in the air) and mimics those actions via the machine parts lifting the user up, or if the user is flying, turn the user the same degree as in the virtual world and hold in this position until it changes. The present invention centralizes all virtual reality to real world movement and vice versa. The present invention allows users to feel movement of their virtual reality counterpart.

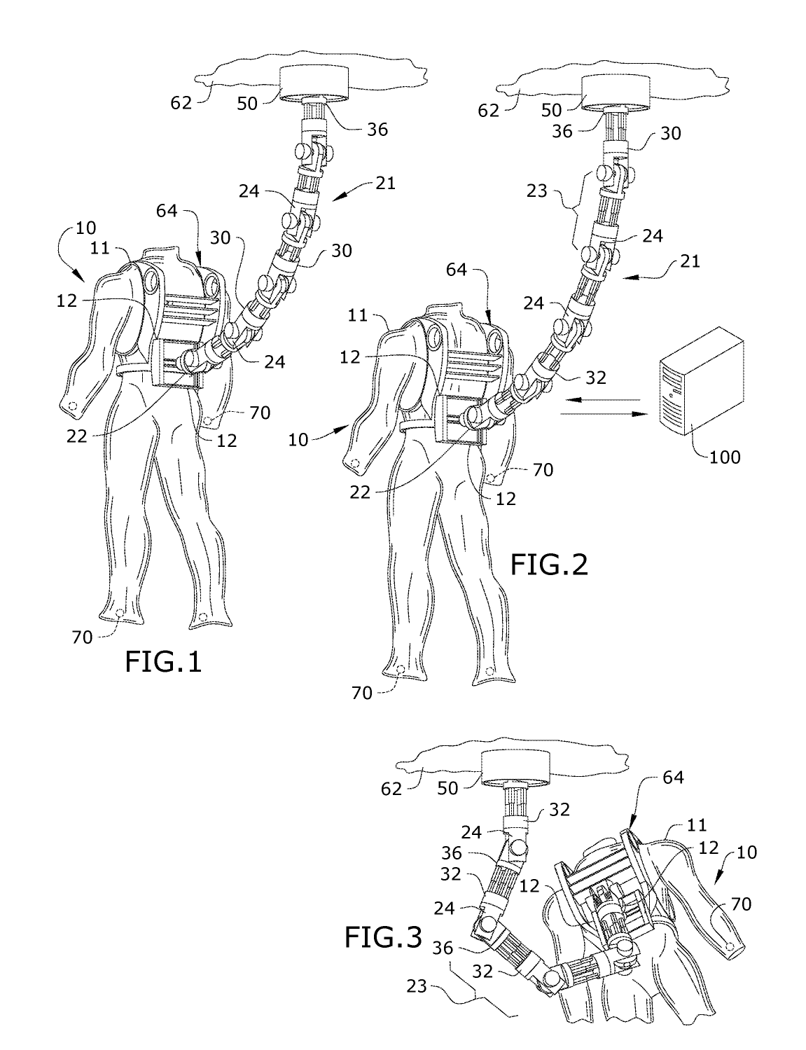

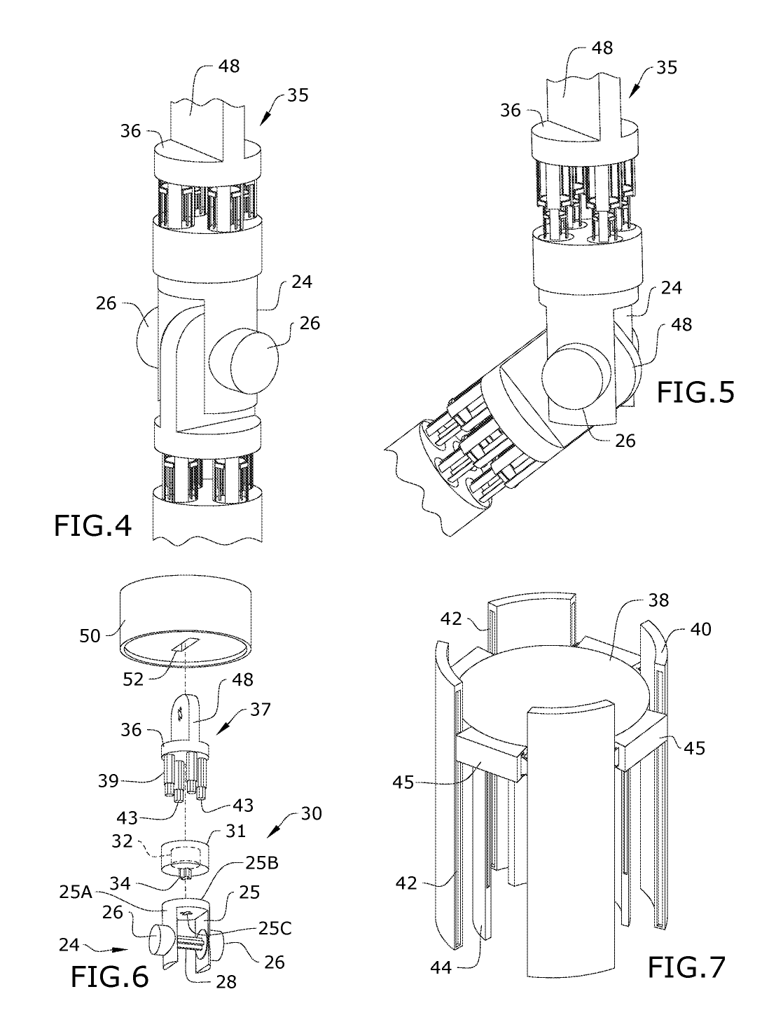

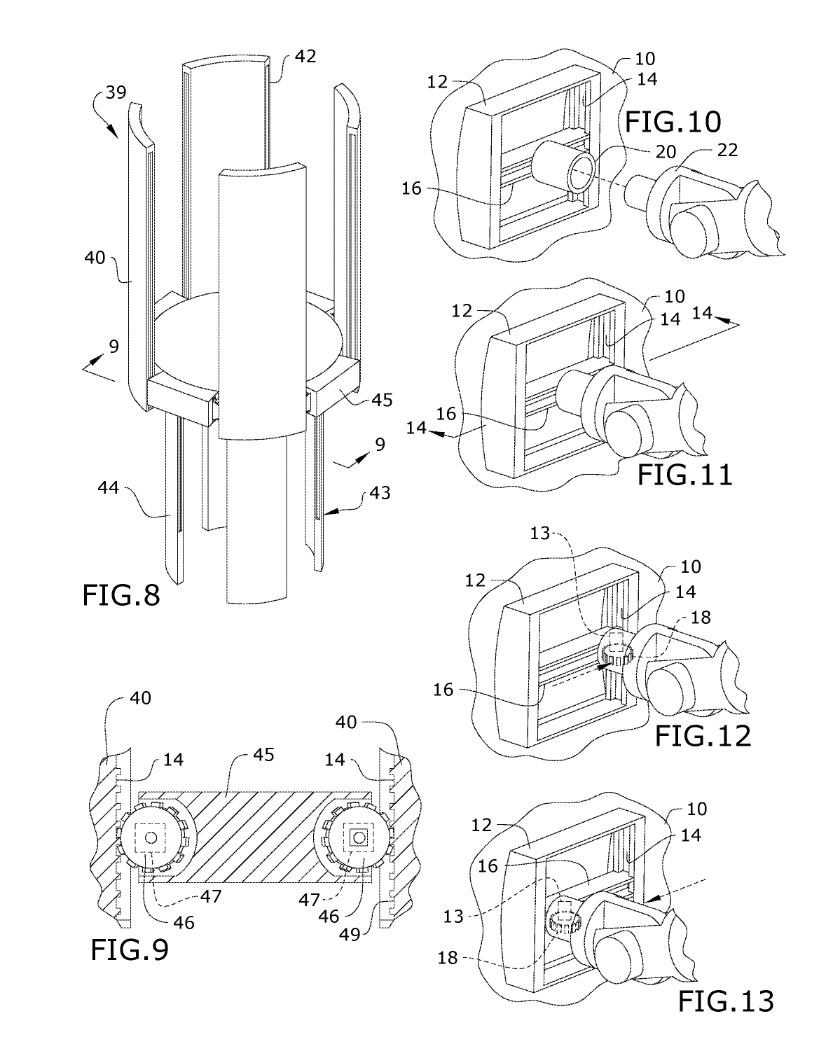

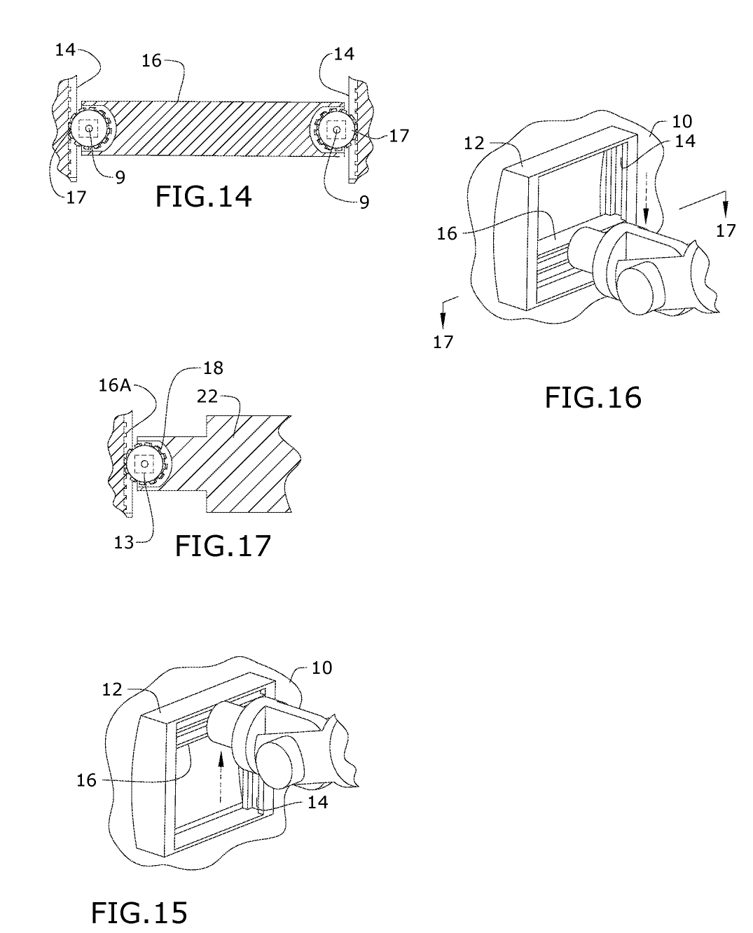

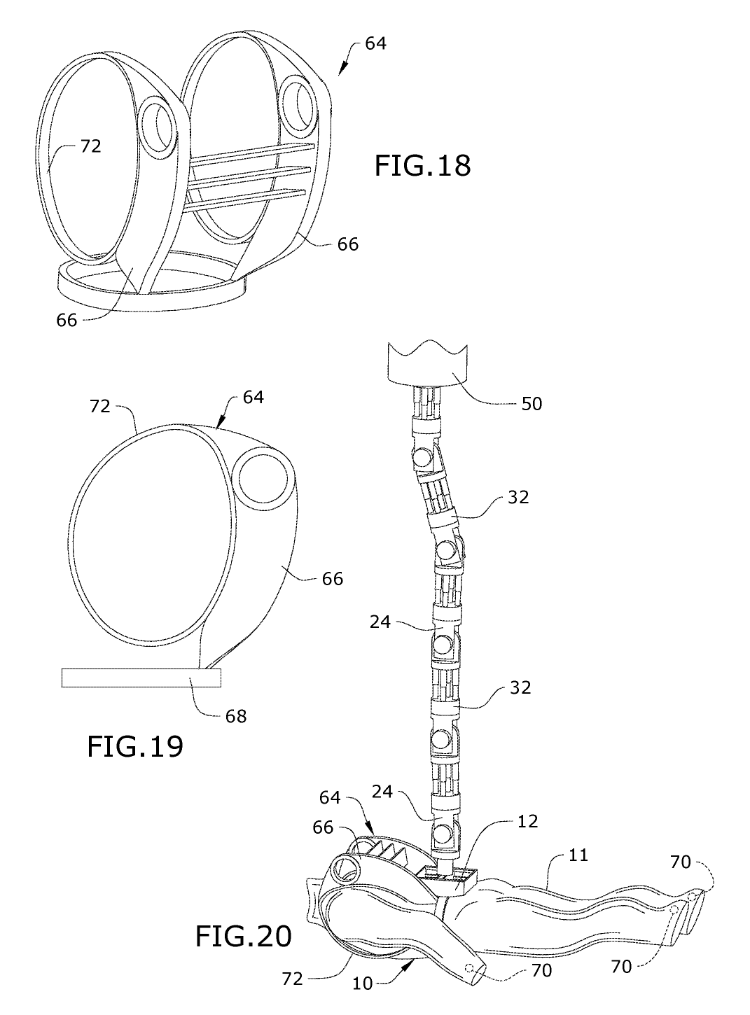

Referring to FIGS. 1 through 18, the present invention includes a virtual reality interface. The virtual reality interface includes a user attachment 10, a robotic arm 21, and a structural mount 50. The user attachment is configured to attach to a body of a user. The structural mount 50 is configured to attach to a structure, such as a ceiling 62. The robotic arm 21 is electrically connected to and controlled by a computer 100. The robotic arm 21 includes a plurality of segments 23 joined together. The plurality of segments 23 at least includes a first end segment 23 coupled to the user attachment 10 and a second end segment 23 coupled to the structural mount 50. A plurality of segments 23 may attach to one another in between the first end segment 23 and the second end segment 23. Each of the segments 23 includes a first pivoting member 24 operable to rotate about a horizontal axis and a second pivoting member 30 operable to rotate about a vertical axis. At least one motor 26, 32 drives the first pivoting member 24 to rotate about the horizontal axis and drives the second pivoting member 30 to rotate about the vertical axis.

The user attachment 10 is secured to the user so that the robotic arm 21 may pick up and support the user above ground. The user attachment 10 may include both a harness 64 and a body suit 11. The harness 64 may include at least a belt 68 and shoulder straps 72. The harness 64 may further includes rails 66 made of a compressible material. The rails 66 may be on the back of the harness 64 and prevents damage of the robotic arm 21 if the user were to accidentally fall backwards. The body suit 11 may cover a substantial portion of the user's torso, arms and legs. In certain embodiments, each of the arm sleeves and leg sleeves of the body suit 11 may include sensors 70. The sensors 70 may detect movement of the user wearing the body suit 11 and send the data to the computer, which effects the experience of Virtual reality.

In certain embodiments, the user attachment 10 may further include an attachment frame 12. The attachment frame 12 may be secured to the back of the harness 64. The attachment frame 12 includes sides each having a vertical gear rail 14. The present invention further includes a horizontal rail 16. The horizontal rail 16 includes opposing ends. A pair of gears 17 are rotatably attached to the ends of the horizontal rail 16. The gears 17 interlock with the vertical gear rails 14. A motor 9 drives the gears 17, moving the horizontal rail 16 up and down relative to the attachment frame 12.

The present invention may further include a frame attachment 22. The frame attachment 22 couples the first end segment 23 to the horizontal rail 16 via an attachment slot 20. The frame attachment 22 includes a gear 18. In such embodiments, the horizontal rail 16 includes a horizontal gear rail 16a. The gear 18 of the frame attachment 22 interlocks with the horizontal gear rail 16a. A motor 13 drives the gear 18, moving the frame attachment 22 side to side relative to the horizontal rail 16.

As mentioned above, each of the segments includes a first pivoting member 24 and a second pivoting member 30. The first pivoting member 24 includes a bracket 25 having a base 25b and arms 25a extending from the base 25b. The first pivoting member 24 further includes a post 28 having ends rotatably connected to the arms 25a. A motor 26 drives the post 28 to rotate about the horizontal axis. In such embodiment, a portion of the frame attachment 22 may fit in between the arms 25a of the first segment 23. The post 28 is coupled to the portion of the frame attachment 22. When the motor 26 rotates the post 28, the frame attachment 22 rotates relative to the first pivoting member 24. The posts 28 of the remaining segments 23 are coupled to adjacent segments 23 of the plurality of segments 23.

The second pivoting member 30 may include a housing 31 and a post 34 rotatably attached to and extending from the housing 31. A motor 32 is disposed within the housing 31. The motor 32 rotates the post 34 about the vertical axis. The post 34 may be coupled to a female connector 25c of the base 25b of the first pivoting member 24. When the motor 32 rotates the post 34, the first pivoting member 24 may rotate relative to the second pivoting member 30 about the vertical axis.

Each of the plurality of segments 23 may further include a linear actuator 37. Motors 47 drive the linear actuator 37 up and down. The linear actuator 37 may include a plurality of actuator members. Each of the actuator members include an outer base 36, an outer telescoping member 39 and an inner telescoping member 43. The outer telescoping member 39 includes a plurality of vertical sidewalls 40 coupled to the outer base 36. Each of the plurality of vertical sidewalls 40 includes opposing outer edges 42 each having a vertical gear rail 49. The inner telescoping member 43 includes an inner base 38, a plurality of vertical sidewalls 44 extending from to the inner base 38 and coupled to the second pivoting member 30 and a plurality of gear housings 45 attached to a perimeter of the inner base 38. Each of the gear housings 45 include a pair of gears 46 that interlock with the vertical gear rails 49. The motors 47 drive the gears 46 moving the inner telescoping member 43 up and down relative to the outer telescoping member 39. The outer base 36 of the second end segment 23 is coupled to the structural mount 50. The outer base 36 of the remaining segments 23 are coupled to an adjacent segment 23 of the plurality of segments 23. For example, a vertical member 48 of the outer base 36 may fit in between the arms 25a of an adjacent segment 23. The post 28 is coupled to the vertical member 48. When the motor 26 rotates the post 28, the vertical member 48 rotates and thereby the adjacent segments 23 rotate relative to one another.

It should be understood, of course, that the foregoing relates to exemplary embodiments of the invention and that modifications may be made without departing from the spirit and scope of the invention as set forth in the following claims.

What is claimed is:

1. A virtual reality interface comprising:
a user attachment configured to attach to a body of a user;
a structural mount configured to attach to a structure;
a robotic arm electrically connected to and controlled by a computer, wherein the robotic arm comprises a plurality of segments joined together, the plurality of segments comprising at least a first end segment coupled to the user attachment and a second end segment coupled to the structural mount, wherein each of the plurality of segments comprise:
a first pivoting member operable to rotate about a horizontal axis; and
a second pivoting member operable to rotate about a vertical axis; and
at least one motor driving the first pivoting member to rotate about the horizontal axis and driving the second pivoting member to rotate about the vertical axis.

2. The virtual reality interface of claim 1, wherein the user attachment comprises a harness comprising at least a belt and shoulder straps.

3. The virtual reality interface of claim 1, wherein the user attachment comprises a body suit comprising arm sleeves and leg sleeves.

4. The virtual reality interface of claim 3, wherein each of the arm sleeves and each of the leg sleeves comprise a sensor operable to send data to the computer.

5. The virtual reality interface of claim 1, wherein the user attachment further comprises an attachment frame comprising opposing sides each comprising a vertical gear rail, and a horizontal rail comprising opposing ends each comprising a gear, wherein the gears interlock with the vertical gear rails, wherein the at least one motor drives the gears, moving the horizontal rail up and down relative to the attachment frame.

6. The virtual reality interface of claim 5, further comprising a frame attachment coupling the first end segment to the horizontal rail, wherein the frame attachment comprises a gear and the horizontal rail comprises a horizontal gear rail, wherein the gear of the frame attachment interlocks with the horizontal gear rail, wherein the at least one motor drives the gear, moving the frame attachment side to side relative to the horizontal rail.

7. The virtual reality interface of claim 1, wherein the first pivoting member comprises:
a bracket comprising a base and arms extending from the base;
a post comprising ends rotatably connected to the arms, wherein
the motor drives the post to rotate about the horizontal axis,
the post of the first end segment is coupled to the user attachment, and
the post of the second end segment is coupled to an adjacent segment of the plurality of segments.

8. The virtual reality interface of claim 1, wherein the second pivoting member comprises:
a housing; and
a post rotatably attached to and extending from the housing, wherein
the at least one motor rotates the post about the vertical axis, and
the post is coupled to the first pivoting member.

9. The virtual reality interface of claim 1, wherein each of the plurality of segments further comprises a linear actuator, wherein the at least one motor drives the linear actuator up and down.

10. The virtual reality interface of claim 9, wherein the linear actuator comprises:
an outer base;
an outer telescoping member comprising a plurality of vertical sidewalls coupled to the outer base, wherein each of the plurality of vertical sidewalls comprises opposing outer edges each comprising a vertical gear rail;
an inner telescoping member comprising an inner base, a plurality of vertical sidewalls extending from to the inner base and coupled to the second pivoting member and a plurality of gear housings attached to a perimeter of the inner base, wherein each of the plurality of gear housings comprise a pair of gears, each of the gears interlocked with one of the vertical gear rails, wherein
the at least one motor drives the gears moving the inner telescoping member up and down relative to the outer telescoping member,
the outer base of the second end segment is coupled to the structural mount, and
the outer base of the first end segment is coupled to an adjacent segment of the plurality of segments.
